(19) United States
(12) Patent Application Publication
(10) Pub. No.: US 2022/0239682 A1
(43) Pub. Date: Jul. 28, 2022

(54) SYSTEM AND METHOD FOR SECURING NETWORKS BASED ON CATEGORICAL FEATURE DISSIMILARITIES

(71) Applicant: Armis Security Ltd., Tel Aviv-Yafo (IL)

(72) Inventors: Gil BEN ZVI, Hod Hasharon (IL); Ron SHOHAM, Tel Aviv (IL); Tom HANETZ, Tel Aviv (IL); Yuval FRIEDLANDER, Petah-Tiqwa, (IL)

(73) Assignee: Armis Security Ltd., Tel Aviv-Yafo (IL)

(21) Appl. No.: 17/161,229

(22) Filed: Jan. 28, 2021

(51) Int. Cl. H04L 29/06; H04L 12/26; G06K 9/62

(52) U.S. Cl. CPC H04L 63/1425; H04L 43/067; G06K 9/6277; G06K 9/6215; H04L 43/062

(57) ABSTRACT

A system and method for detecting deviations from baseline behavior patterns for categorical features. A method includes determining a first discrete probability distribution for a categorical variable based on a first set of network activity data; determining a second discrete probability distribution for a unique observation based on a second set of network activity data; comparing the second discrete probability distribution to the first discrete probability distribution by applying a distance function to the first and second discrete probability distributions, wherein an output of the distance function is a scalar value representing a difference between the first and second discrete probability distributions; determining whether the scalar value is above a threshold; detecting an anomaly with respect to the categorical variable when the scalar value is above the threshold; and determining that a behavior with respect to the categorical variable is normal when the scalar value is not above the threshold.

### TECHNICAL FIELD

The present disclosure relates generally to network security, and more specifically to securing networks based on anomalies in categorical features.

### BACKGROUND

Network devices that share common characteristics tend to have predictable behavioral patterns over time. By accumulating a large amount of data over device populations, these behavioral patterns can be captured as a distribution of baseline behavior in an exhaustive and reliable manner. To this end, crowdsourcing strategies could be used to learn these behavioral patterns.

Certain features pertaining to device behavioral patterns is categorical in nature rather than numerical. For example, the ports and hosts used by a given device are features which are expressed with respect to categories rather than numerical values. Categorical data is data which falls into one or more groupings, or categories, and cannot be effectively expressed numerically. For example, the color of an object is categorical (e.g., red, blue, green, etc.) as opposed to numerical.

For these types of categorical features, standard statistical methods for measuring variable distribution characteristics cannot be applied. Even if numbers were assigned to different categories (thereby “representing” the categories using numbers), applying statistical methods to those numbers directly does not provide any meaningful information about the data itself. In the color example above, taking an average of values representing those colors would not effectively represent the “average” color indicated in data including those values. Accordingly, existing solutions face challenges in detecting deviations from baseline behavior patterns for these categorical features.

It would therefore be advantageous to provide a solution that would overcome the challenges noted above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

Certain embodiments disclosed herein include a method for detecting deviations from baseline behavior patterns for categorical features. The method comprises: determining a first discrete probability distribution for a categorical variable based on a first set of network activity data including at least one instance of the categorical variable; determining a second discrete probability distribution for a unique observation based on a second set of network activity data including data representing the unique observation; comparing the second discrete probability distribution to the first discrete probability distribution by applying a distance function to the first and second discrete probability distributions, wherein an output of the distance function is a scalar value representing a difference between the first and second discrete probability distributions; determining whether the scalar value is above a threshold; detecting an anomaly with respect to the categorical variable when the scalar value is above the threshold; and determining that a behavior with respect to the categorical variable is normal when the scalar value is not above the threshold.

Certain embodiments disclosed herein also include a non-transitory computer readable medium having stored thereon causing a processing circuitry to execute a process, the process comprising: determining a first discrete probability distribution for a categorical variable based on a first set of network activity data including at least one instance of the categorical variable; determining a second discrete probability distribution for a unique observation based on a second set of network activity data including data representing the unique observation; comparing the second discrete probability distribution to the first discrete probability distribution by applying a distance function to the first and second discrete probability distributions, wherein an output of the distance function is a scalar value representing a difference between the first and second discrete probability distributions; determining whether the scalar value is above a threshold; detecting an anomaly with respect to the categorical variable when the scalar value is above the threshold; and determining that a behavior with respect to the categorical variable is normal when the scalar value is not above the threshold.

Certain embodiments disclosed herein also include a system for detecting deviations from baseline behavior patterns for categorical features. The system comprises: a processing circuitry; and a memory, the memory containing instructions that, when executed by the processing circuitry, configure the system to: determine a first discrete probability distribution for a categorical variable based on a first set of network activity data including at least one instance of the categorical variable; determine a second discrete probability distribution for a unique observation based on a second set of network activity data including data representing the unique observation; compare the second discrete probability distribution to the first discrete probability distribution by applying a distance function to the first and second discrete probability distributions, wherein an output of the distance function is a scalar value representing a difference between the first and second discrete probability distributions; determine whether the scalar value is above a threshold; detect an anomaly with respect to the categorical variable when the scalar value is above the threshold; and determine that a behavior with respect to the categorical variable is normal when the scalar value is not above the threshold.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a network diagram utilized to describe various disclosed embodiments.

FIG. 2 is a flowchart illustrating a method for detecting a deviation from a baseline for categorical features according to an embodiment.

FIG. 3 is a flowchart illustrating a method for determining a discrete probability distribution according to an embodiment.

FIG. 4 is a flowchart illustrating a method for attributes identification based on categorical features according to an embodiment.

FIG. 5 is a schematic diagram of an anomaly detector according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The various disclosed embodiments include techniques for detecting deviations from baseline behaviors related to categorical features as well as techniques for utilizing such detected deviations in network security. During a training phase, a discrete probability distribution is determined for each of one or more categorical variables. During an application phase, instances of each categorical variable among network data are modeled as discrete probability distributions. A distance function is applied over a pair of two probability distributions for each categorical value in order to yield a set of scalar values that collectively describe the differences in behaviors between the expected and observed distributions. The pair of probability distributions for each categorical variable include the probability distribution determined during the training for that variable and the probability distribution determined during the application phase for that variable.

Based on the output of the distance function as applied to the probability distributions of each variable, it is determined whether and which of the categorical variables have deviated from a baseline behavior represented by the training probability distribution. Any such deviations are detected as anomalies. Based on the detected anomalies, one or more mitigation actions may be performed.

The disclosed embodiments can be utilized to learn and detect deviations from baseline behaviors for features which are expressed using categorical data rather than numerical data. Such categorical data is expressed using groups or categories with respect to characteristics that are mutually exclusive, i.e., such that a given portion of the data can only be placed into one such category. Even when categorical data is represented using numerical values (e.g., assigning “1” to represent a first category, “2” to represent a second category, etc.), trends in the categorical data cannot be effectively represented by applying certain kinds of statistical calculations to the categorical data. For example, calculating the average value for categories representing different ports of a system does not logically represent trends in port usage.

The disclosed embodiments also include embodiments for utilizing outputs of difference functions as described herein in order to identify attributes of devices or systems. More specifically, the output of a difference function may be compared to a threshold and, if the output is below the threshold, it may be determined that the behavior of the device or system with respect to the categorical variable is normal. The results of determining whether behavior is normal with respect to one or more categorical variables may be utilized in combination with similarity rules in order to determine whether the behavior pattern of the device or system is sufficiently similar to devices and systems having a particular attribute.

The embodiments disclosed herein provide techniques which allow for effectively representing trends in categorical behaviors using statistical calculations. Accordingly, the disclosed embodiments provide new techniques for measuring baseline behavior patterns and, therefore, detecting deviations from those baseline behavior patterns. Thus, the disclosed embodiments allow for detecting new kinds of deviations in network activity data which, in turn, allow for improving network security by mitigating threats related to those detected deviations.

In this regard, it has been identified that use of discrete probability distributions and distance functions can be utilized to effectively represent differences for categorical variables such that, by incorporating such discrete probability distributions and distance functions into an anomaly detection process, the accuracy of the anomaly detection process may be improved by allowing for detecting new types of anomalies, thereby reducing the number of false negative results (i.e., failing to detect anomalies). It has further been identified that discrete probability distributions and distance functions can similarly be utilized to identify normal behavior with respect to particular attributes which behave predictably. Identifying such normal behavior, in turn, may be utilized to identifying those attributes in devices exhibiting such normal behaviors.

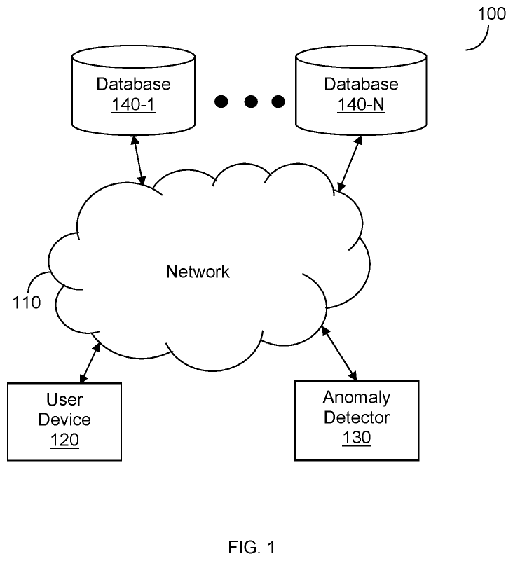

FIG. 1 shows an example network diagram 100 utilized to describe the various disclosed embodiments. In the example network diagram 100, a user device 120, an anomaly detector 130, and a plurality of databases 140-1 through 140-N (hereinafter referred to individually as a database 140 and collectively as databases 140, merely for simplicity purposes) are communicatively connected via a network 110. The network 110 may be, but is not limited to, a wireless, cellular or wired network, a local area network (LAN), a wide area network (WAN), a metro area network (MAN), the Internet, the worldwide web (WWW), similar networks, and any combination thereof.

The user device (UD) 120 may be, but is not limited to, a personal computer, a laptop, a tablet computer, a smartphone, a wearable computing device, or any other device capable of receiving and displaying notifications. In some implementations, the user device 120 may be operated by an admin of an organization or other person who may desire to be notified of identified anomalies or mitigations actions being performed.

The anomaly detector 130 is configured to detect anomalies in categorical data as described herein. More specifically, the anomaly detector 130 is configured to retrieve data related to network activity, to determine probability distributions for categorical variables represented in such data, to determine differences between probability distributions for each categorical variable, and to identify anomalies based on the determined differences.

To this end, the databases 140 may store such network activity data to be analyzed by the anomaly detector 130. Alternatively or in combination, the anomaly detector 130 may receive such network activity data directly from systems (not shown) deployed in a subject network (not shown) or otherwise configured to collect data based on activities of devices and systems operating within or connected to the subject network. The subject network may be, for example but not limited to, a network of an organization or other network for which cybersecurity protection is desired.

In an embodiment, the network activity data to be analyzed by the anomaly detector 130 includes instances of categorical variables. As non-limiting examples, such categorical variables may include, but are not limited to, the hosts each device connects to, ports used by each device or system, communication channels by which each device or system communicates, and the like.

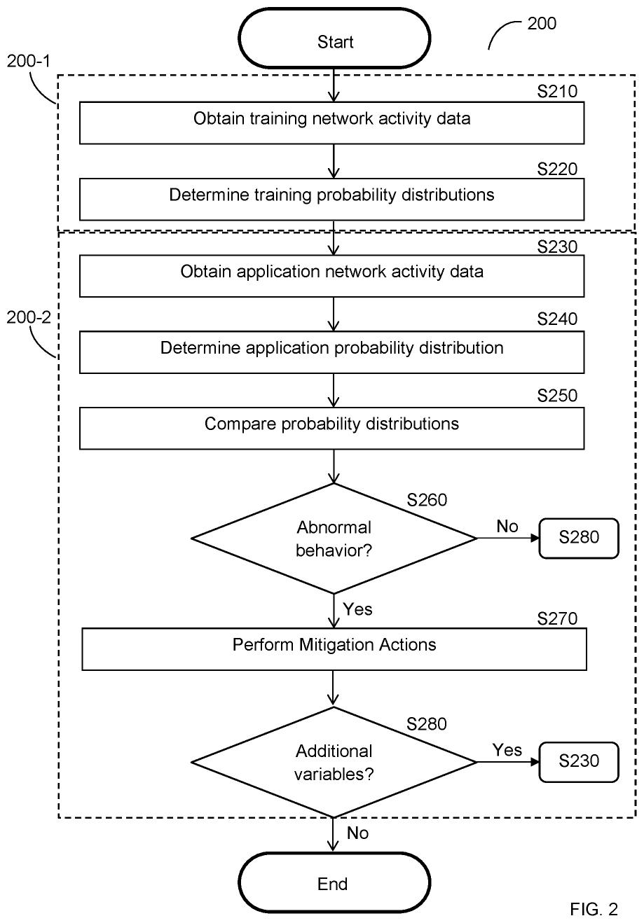

FIG. 2 is a flowchart 200 illustrating a method for detecting a deviation from a baseline for categorical features according to an embodiment. In an embodiment, the method is performed by the anomaly detector 130, FIG. 1.

In an embodiment, the method includes a training phase 200-1 and an application phase 200-2. During the training phase 200-1, a first training probability distribution is created based on network behavior captured during the training phase 200-1. During the application phase 200-2, a second application probability distribution is created based on network behavior captured during the application phase 200-2, and the first and second probability distributions are compared in order to identify any deviations from baseline network behavior.

At S210, during a training phase 200-1, training network activity data is obtained. The training network activity data includes data related to devices and systems communicating in or connected to a subject network, and includes instances of categorical variables such as, but not limited to, the hosts each device or system connects to, ports used by each device or system, communication channels by which each device or system communicates, and the like. The training network activity data may be retrieved (e.g., from one or more of the databases 140, FIG. 1) or may be received (e.g., from a device or system operating in the subject network).

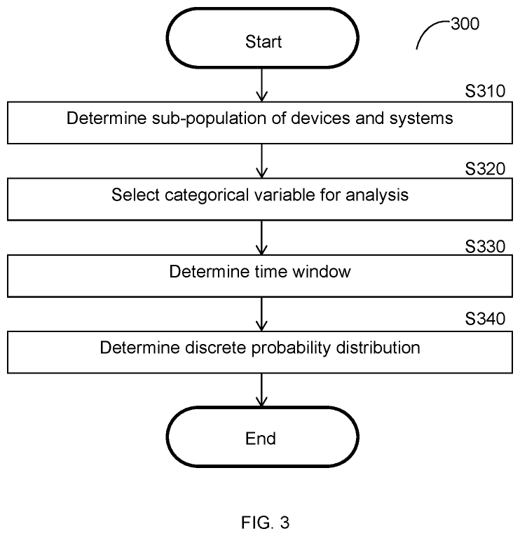

At S220, one or more first training discrete probability distributions are determined based on the training network activity data. The training probability distribution is determined for a categorical variable having instances which are included in the training network activity data. In an embodiment, the training probability distribution is determined as described further below with respect to FIG. 3.

At S230, during an application phase 200-2, application network activity data is obtained. The application network activity data includes data related to devices and systems communicating in or connected to a subject network, and includes instances of categorical variables such as, but not limited to, the hosts each device or system connects to, ports used by each device or system, communication channels by which each device or system communicates, and the like. The application network activity data may be retrieved (e.g., from one or more of the databases 140, FIG. 1) or may be received (e.g., from a device or system operating in the subject network).

At S240, a second application discrete probability distribution is determined based on the application network activity data. The application probability distribution is determined for a categorical variable having instances which are included in the application network activity data. In an embodiment, the application probability distribution is determined as described further below with respect to FIG. 3.

At S250, one or more of the training probability distributions are compared to the application probability distribution. In an embodiment, S250 includes applying a predetermined distance function in order to calculate a difference between the probability distributions.

In an embodiment, the distance function is determined such that the function outputs a scalar value. The scalar value is a distribution dissimilarity feature value representing a difference between the compared probability distributions and the value output by the distance function increases as the difference between the compared probability distributions increases. Non-limiting example distance functions which may be used to output such a scalar value include cross-entropy distance functions and chi-squared statistic functions.

In a further embodiment, the distance function may support cases in which one of the probability distributions for one of the categories is absent among the training application network activity data (i.e., when there are no instances of the categorical variable among the network activity data). In yet a further embodiment, the distance function is determined such that, when there are no instances of a categorical variable among the training network activity data corresponding to a unique observation in the application network activity data, the distance function returns its maximum value (e.g., when the output of the distance function ranges from 0 to 1, 1 would be returned since 1 is the maximum possible value for the distance function).

At S260, based on the comparison, it is determined whether the application network activity data demonstrates abnormal behavior with respect to the categorical variable for which the training and application probability distributions were determined. If so, an anomaly is detected and execution continues with S270; otherwise, execution continues with S280. In an embodiment, an anomaly is detected when the scalar value output by the distance function is above a threshold; otherwise (i.e., when the scalar value is not above the threshold), it is determined that behavior of the device or system with respect to the categorical variable is normal. To this end, in such an embodiment, S260 includes comparing the scalar value to the threshold. Further, different thresholds may be utilized for different categorical variables such that the scalar value needed to trigger an anomaly is higher for some categorical variables than for others. In another embodiment, the scalar value output by the distance function may be input to an anomaly detection model, which is configured to output an indicator of whether the behavior is anomalous. In other words, in such an embodiment, the threshold may be learned via machine learning and set during processing such that the threshold is adjusted depending on the training data used for the anomaly detection algorithm.

At S270, when an anomaly is detected, one or more mitigation actions are performed. The mitigation actions may include, but are not limited to, disconnecting devices or systems from the network, turning off one or more ports (e.g., by reconfiguring devices to stop using those ports), by disconnecting devices or systems from certain hosts, combinations thereof, and the like. In an embodiment, the type(s) of mitigation action(s) to be performed may be determined based on the categorical variables for which anomalies were detected (i.e., categorical variables for which the distribution dissimilarity values are above a threshold).

In an embodiment, S270 may further include generating and sending a notification (e.g., to the user device 120, FIG. 1). The notification may indicate, for example, the detected anomalies, the mitigation actions performed, both, and the like.

At S280, it is determined whether additional categorical variables should be analyzed and, if so, execution continues with S230; otherwise, execution terminates. It should be noted that analysis of additional categorical variables is depicted as occurring after the analysis of the first categorical variable merely for simplicity, but that the other categorical variables may be analyzed in parallel without departing from the scope of the disclosure. Further, the training phases of all categorical variables are not necessarily completed before any application phases begin, and some categorical variables may be in the training phase while others are in the application phase without departing from the scope of the disclosure.

It should be noted that single, distinct training and application phases 200-1 and 200-2 are depicted in FIG. 2 for simplicity of discussion, but that the training (via creation of training probability distributions) may continue during or after the application phase 200-2 without departing from the scope of the disclosure. As a non-limiting example, one or more probability distribution created during the application phase 200-2 may be added to the training probability distributions, for example, when anomalies are not detected based on those probability distributions.

FIG. 3 is a flowchart illustrating a method 300 for determining a discrete probability distribution according to an embodiment. In an embodiment, the method is performed by the anomaly detector 130, FIG. 1.

At S310, a sub-population of devices and/or systems indicated in network activity data is determined. The sub-population may be determined based on a common attribute. As a non-limiting example, the sub-population may include all devices which are voice over Internet Protocol (VOIP) devices.

During a training phase, the sub-population of devices may be one or more devices sharing a predetermined common attribute. During an application phase (e.g., the application phase 200-2, FIG. 1), the sub-population may be a device or system for which a unique observation was identified. The sub-population determined for training and application phases may be different such that training based on one sub-population can be used to determine scalar values and detect abnormal behavior for other sub-populations. As a non-limiting example, the training and application phases may both be based on data from the same device, or the training may be based on data from a first device and the application may be based on data from one or more second devices having similar attributes to the first device. Devices having similar attributes may be, but are not limited to, devices having specific attributes in common, devices having a threshold number of attributes in common, both, and the like.

At S320, a categorical variable for which a discrete probability distribution should be determined is selected for analysis. During a training phase, the selected categorical variable is one of the categorical variables among the training network activity data. During an application phase, the selected categorical variable is variable, field, or feature which might be used as an attribute for a specific observation. Each observation is a unique instance of a given entity (e.g., a given device or system).

At S330, a time window is determined such that the activity of the device or system with respect to the selected categorical variable is assumed to be fully observed for the determined sub-population. In an embodiment, during a training phase, the time window may be determined based on the selected categorical variable. The time window may be selected from among a set of predetermined time windows associated with corresponding categorical variables, and the time window may be determined based on the categorical variable selected for analysis. As a non-limiting example, the determined time period may be a one-week period for the categorical variable host distribution (i.e., the hosts with which a device or system communicates). During an application phase, the time window may be determined such that the time windows determined in the training and application phases have the same duration (e.g., both one week time periods).

At S340, a discrete probability distribution is determined for the selected categorical variable based on a portion of the network activity data related to the sub-population of devices in the chosen time window.

The discrete probability distribution indicates a probability of each possible category of a categorical variable based on a frequency of instances of that category in a given time period. As a non-limiting example, a device communicates with three hosts “A,” “B,” and “C” during a given week with 100 instances of communicating with host A, 200 instances of communicating with host B, and 300 instances of communicating with host C (i.e., a total of 600 instances of host communications). For this example, the discrete probability distribution would be 16.7% (0.167) for host A (100/600), 33.3% (0.333) for host B (200/600), and 50.0% (0.5) for host C (300/600), with each probability being rounded to the third decimal for simplicity.

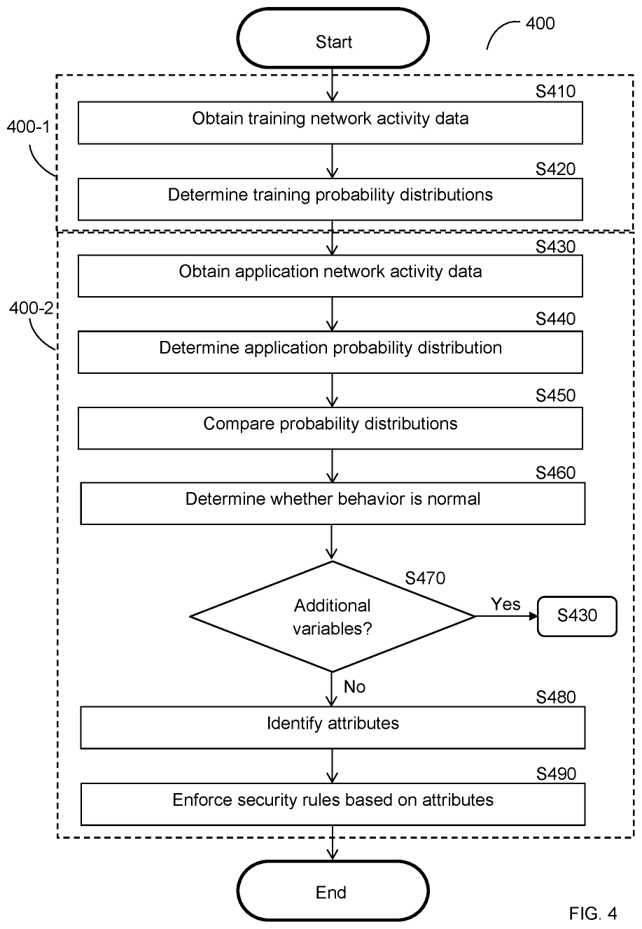

FIG. 4 is a flowchart 400 illustrating a method for attribute identification based on categorical features according to an embodiment. In an embodiment, the method is performed by the anomaly detector 130, FIG. 1, or a similarly configured system having stored thereon instructions for performing the method of FIG. 4s.

In an embodiment, the method includes a training phase 400-1 and an application phase 400-2. During the training phase 400-1, a first training probability distribution is created based on network behavior captured during the training phase 400-1. During the application phase 400-2, a second application probability distribution is created based on network behavior captured during the application phase 400-2, and the first and second probability distributions are compared in order to determine whether newly observed network behavior is similar to baseline network behavior such that an attribute represented by the baseline network behavior can be identified in the newly observed network behavior.

At S410, during a training phase 400-1, training network activity data is obtained. The training network activity data includes data related to devices and systems communicating in or connected to a subject network, and includes instances of categorical variables such as, but not limited to, the hosts each device or system connects to, ports used by each device or system, communication channels by which each device or system communicates, and the like. The training network activity data may be retrieved (e.g., from one or more of the databases 140, FIG. 1) or may be received (e.g., from a device or system operating in the subject network).

At S420, one or more first training discrete probability distributions are determined based on the training network activity data. The training probability distribution is determined for a categorical variable having instances which are included in the training network activity data. In an embodiment, the training probability distribution is determined as described further above with respect to FIG. 3.

At S430, during an application phase 400-2, application network activity data is obtained. The application network activity data includes data related to devices and systems communicating in or connected to a subject network, and includes instances of categorical variables such as, but not limited to, the hosts each device or system connects to, ports used by each device or system, communication channels by which each device or system communicates, and the like. The application network activity data may be retrieved (e.g., from one or more of the databases 140, FIG. 1) or may be received (e.g., from a device or system operating in the subject network).

At S440, a second application discrete probability distribution is determined based on the application network activity data. The application probability distribution is determined for a categorical variable having instances which are included in the application network activity data. In an embodiment, the application probability distribution is determined as described further above with respect to FIG. 3.

At S450, one or more of the training probability distributions are compared to the application probability distribution. In an embodiment, S450 includes applying a predetermined distance function in order to calculate a difference between the probability distributions.

In an embodiment, the distance function is determined such that the function returns a scalar value. The scalar value is a distribution dissimilarity feature value representing a difference between the compared probability distributions and the value output by the distance function increases as the difference between the compared probability distributions increases. Non-limiting example distance functions which may be used to output such a scalar value include cross-entropy distance functions and chi-squared statistic functions.

In a further embodiment, the distance function may support cases in which one of the probability distributions is absent for one of the categories among the training application network activity data (i.e., when there are no instances of the categorical variable among the network activity data). In yet a further embodiment, the distance function is determined such that, when there are no instances of a categorical variable among the training network activity data corresponding to an observation in the application network activity data, the distance function returns its maximum value (e.g., when the output of the distance function ranges from 0 to 1, 1 would be returned).

At S460, based on the comparison, it is determined whether the application network activity data for a given time period is normal as compared to the training network activity data for the categorical variable. In an embodiment, the application network activity data is determined to be normal for the time period with respect to the categorical variable when the scalar value output by the distance function is below a predetermined threshold. Further, different thresholds may be utilized for different categorical variables such that the scalar value needed to determine abnormal behavior is higher for some categorical variables than for others. In another embodiment, the scalar value output by the distance function may be input to an anomaly identification algorithm in order to output a value indicating whether the activity represented by the scalar value is anomalous.

At S470, it is determined whether additional categorical variables should be analyzed and, if so, execution continues with S430; otherwise, execution continues with S480.

It should be noted that analysis of additional categorical variables is depicted as occurring after the analysis of the first categorical variable merely for simplicity, but that the other categorical variables may be analyzed in parallel without departing from the scope of the disclosure. Further, the training phases of all categorical variables are not necessarily completed before any application phases begin, and some categorical variables may be in the training phase while others are in the application phase without departing from the scope of the disclosure.

At S480, based on the comparisons between probability distributions and one or more similarity rules for different possible attributes, it is determined whether a pattern of behavior for the application training data is indicative of one of those possible attributes. If so, the device or system is identified as having the indicated attributes. As a non-limiting example, an attribute may be an operating system such that different attributes may include different types of operating systems. The similarity rules may be unique for each attribute such that a given set of behaviors is unlikely or impossible to result in multiple conflicting attributes (e.g., multiple operating system types) being identified. The similarity rules may require, for example, a threshold number of matches for categorical variables, specific matching categorical variables, a combination thereof, and the like. The similarity rules may further require additional similarities in behavior, e.g., similarities in numerical values.

At optional S490, one or more security rules may be enforced based on the identified attributes. As a non-limiting example, different sets of security rules may be enforced for devices having different operating systems.

In this regard, it is noted that devices and systems with different attributes (e.g., different operating system types) may behave differently with respect to categorical variables such that the comparison of behavior vis-a-vis categorical variables as described above can be utilized to provide additional information relevant to uniquely identifying those attributes based on network activity data. Accordingly, the probability distribution comparisons described above can be applied to more accurately identify attributes of devices and systems operating within the network by providing more of such relevant information for analysis. Consequently, any security rules applied based on these identified attributes are more likely to be appropriate for a particular device or system, thereby improving security of the network.

It should be noted that single, distinct training and application phases 400-1 and 400-2 are depicted in FIG. 4 for simplicity of discussion, but that the training (via creation of training probability distributions) may continue during or after the application phase 400-2 without departing from the scope of the disclosure. As a non-limiting example, one or more probability created during the application phase 400-2 may be added to the training probability distributions, for example, when anomalies are not detected based on those probability distributions.

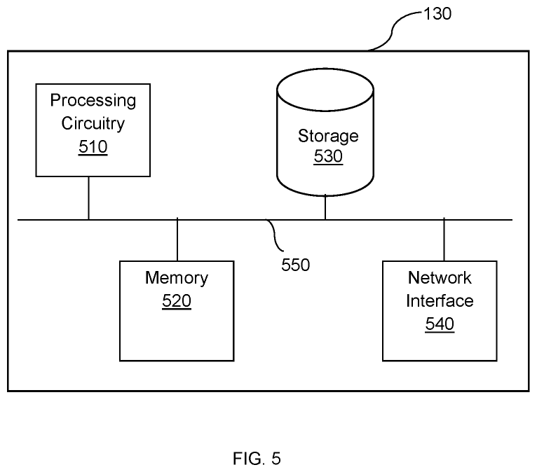

FIG. 5 is an example schematic diagram of an anomaly detector 130 according to an embodiment. The anomaly detector 130 includes a processing circuitry 510 coupled to a memory 520, a storage 530, and a network interface 540. In an embodiment, the components of the anomaly detector 130 may be communicatively connected via a bus 550.

The processing circuitry 510 may be realized as one or more hardware logic components and circuits. For example, and without limitation, illustrative types of hardware logic components that can be used include field programmable gate arrays (FPGAs), application-specific integrated circuits (ASICs), Application-specific standard products (ASSPs), system-on-a-chip systems (SOCs), graphics processing units (GPUs), tensor processing units (TPUs), general-purpose microprocessors, microcontrollers, digital signal processors (DSPs), and the like, or any other hardware logic components that can perform calculations or other manipulations of information.

The memory 520 may be volatile (e.g., random access memory, etc.), non-volatile (e.g., read only memory, flash memory, etc.), or a combination thereof.

In one configuration, software for implementing one or more embodiments disclosed herein may be stored in the storage 530. In another configuration, the memory 520 is configured to store such software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the processing circuitry 510, cause the processing circuitry 510 to perform the various processes described herein.

The storage 530 may be magnetic storage, optical storage, and the like, and may be realized, for example, as flash memory or other memory technology, compact disk-read only memory (CD-ROM), Digital Versatile Disks (DVDs), or any other medium which can be used to store the desired information.

The network interface 540 allows the anomaly detector 130 to communicate with, for example, the user device 120, the databases 140, both, and the like.

It should be understood that the embodiments described herein are not limited to the specific architecture illustrated in FIG. 5, and other architectures may be equally used without departing from the scope of the disclosed embodiments.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; 2A; 2B; 2C; 3A; A and B in combination; B and C in combination; A and C in combination; A, B, and C in combination; 2A and C in combination; A, 3B, and 2C in combination; and the like.

What is claimed is:

1. A method for detecting deviations from baseline behavior patterns for categorical features, comprising:
determining a first discrete probability distribution for a categorical variable based on a first set of network activity data including at least one instance of the categorical variable;
determining a second discrete probability distribution for a unique observation based on a second set of network activity data including data representing the unique observation;
comparing the second discrete probability distribution to the first discrete probability distribution by applying a distance function to the first and second discrete probability distributions, wherein an output of the distance function is a scalar value representing a difference between the first and second discrete probability distributions;
determining whether the scalar value is above a threshold;
detecting an anomaly with respect to the categorical variable when the scalar value is above the threshold; and
determining that a behavior with respect to the categorical variable is normal when the scalar value is not above the threshold.

2. The method of claim 1, further comprising:
performing at least one mitigation when an anomaly is detected.

3. The method of claim 1, wherein determining the first discrete probability distribution further comprises:
determining a time window such that activity with respect to the categorical variable is assumed to be fully observed during the determined time window, wherein a duration of the time window is based on a type of the categorical variable, wherein the first discrete probability distribution function is determined based on a portion of the first set of network activity data corresponding to the determined time window.

4. The method of claim 1, wherein determining the first discrete probability distribution further comprises:
determining a sub-population of devices and systems indicated in the first network activity data, wherein the sub-population of devices and systems has a common attribute, wherein the portion of the first set of network activity data corresponding to the determined time window is related to the sub-population of devices.

5. The method of claim 1, wherein the scalar value increases as the difference between the first and second discrete probability distributions increases.

6. The method of claim 1, wherein the threshold is associated with the categorical variable.

7. The method of claim 1, wherein each discrete probability distribution indicates a probability of each of a plurality of potential categories for the categorical variable.

8. The method of claim 1, wherein the distance function is any of: a cross-entropy distance function, and a chi-squared statistic function.

9. The method of claim 1, wherein the categorical variable is any of: a host, a communication channel, and a port.

10. A non-transitory computer readable medium having stored thereon instructions for causing a processing circuitry to execute a process, the process comprising:
determining a first discrete probability distribution for a categorical variable based on a first set of network activity data including at least one instance of the categorical variable;
determining a second discrete probability distribution for a unique observation based on a second set of network activity data including data representing the unique observation;
comparing the second discrete probability distribution to the first discrete probability distribution by applying a distance function to the first and second discrete probability distributions, wherein an output of the distance function is a scalar value representing a difference between the first and second discrete probability distributions;
determining whether the scalar value is above a threshold;
detecting an anomaly with respect to the categorical variable when the scalar value is above the threshold; and
determining that a behavior with respect to the categorical variable is normal when the scalar value is not above the threshold.

11. A system for detecting deviations from baseline behavior patterns for categorical features, comprising:
a processing circuitry; and
a memory, the memory containing instructions that, when executed by the processing circuitry, configure the system to:
determine a first discrete probability distribution for a categorical variable based on a first set of network activity data including at least one instance of the categorical variable;
determine a second discrete probability distribution for a unique observation based on a second set of network activity data including data representing the unique observation;
compare the second discrete probability distribution to the first discrete probability distribution by applying a distance function to the first and second discrete probability distributions, wherein an output of the distance function is a scalar value representing a difference between the first and second discrete probability distributions;
determine whether the scalar value is above a threshold;
detect an anomaly with respect to the categorical variable when the scalar value is above the threshold; and
determine that a behavior with respect to the categorical variable is normal when the scalar value is not above the threshold.

12. The system of claim 11, wherein the system is further configured to:
perform at least one mitigation when an anomaly is detected.

13. The system of claim 11, wherein the system is further configured to:
determine a time window such that activity with respect to the categorical variable is assumed to be fully observed during the determined time window, wherein a duration of the time window is based on a type of the categorical variable, wherein the first discrete probability distribution function is determined based on a portion of the first set of network activity data corresponding to the determined time window.

14. The system of claim 11, wherein the system is further configured to:
determine a sub-population of devices and systems indicated in the first network activity data, wherein the sub-population of devices and systems has a common attribute, wherein the portion of the first set of network activity data corresponding to the determined time window is related to the sub-population of devices.

15. The system of claim 11, wherein the scalar value increases as the difference between the first and second discrete probability distributions increases.

16. The system of claim 11, wherein the threshold is associated with the categorical variable.

17. The system of claim 11, wherein each discrete probability distribution indicates a probability of each of a plurality of potential categories for the categorical variable.

18. The system of claim 11, wherein the distance function is any of: a cross-entropy distance function, and a chi-squared statistic function.

19. The system of claim 11, wherein the categorical variable is any of: a host, a communication channel, and a port.
